(19) United States
(12) Patent Application Publication
(10) Pub. No.: US 2024/0300081 A1
(43) Pub. Date: Sep. 12, 2024

(54) DRIVING TOOL

(71) Applicant: MAKITA CORPORATION, Anjo-shi (JP)

(72) Inventors: Norikazu BABA, Anjo-shi (JP); Shun KURIKI, Anjo-shi (JP); Kiyonobu YOSHIKANE, Anjo-shi (JP); Toshiya MURAKAMI, Anjo-shi (JP)

(73) Assignee: MAKITA CORPORATION, Anjo-shi (JP)

(21) Appl. No.: 18/406,313

(22) Filed: Jan. 8, 2024

(30) Foreign Application Priority Data
Mar. 7, 2023 (JP) 2023-034519
Aug. 10, 2023 (JP) 2023-130992

(51) Int. Cl. B25C 1/18

(52) U.S. Cl. CPC B25C 1/184; B25C 1/188; B25C 1/06

(57) ABSTRACT

A lock member is slidably provided in a pusher that pushes driven members in a feed direction. An engaging portion of the lock member engages a locking portion of a contact arm to restrict an ON operation of the contact arm. The lock member is relatively retracted against a lock biasing member when the engaging portion is pressed against the contact arm.

### CROSS-REFERENCE TO RELATED APPLICATIONS

This application claims priority to Japanese patent application serial numbers 2023-034519 filed Mar. 7, 2023 and 2023-130992 filed Aug. 10, 2023, the contents of which are incorporated herein by reference in their entirety for all purposes.

### BACKGROUND

The present disclosure relates to a driving tool for driving a driven member into a workpiece.

A driving tool is equipped with a magazine that accommodates a number of driven members. The accommodated driven members are pushed by a spring-loaded pusher, for example, to be fed into a driving channel. The magazine is equipped with an idle striking prevention mechanism to prevent so-called idle striking. The idle striking prevention mechanism restricts a driving operation when the number of remaining driven members reaches a certain number. According to the idle striking prevention mechanism disclosed in prior art publications, when the number of remaining driven members reaches a certain number and the pusher reaches a specific position, a lock member enters a movement path of a contact arm. This regulates the contact arm to move, thereby restricting the driving operation.

In one publication, the lock member is provided rotatably in a direction away from the contact arm. This structure avoids the lock member to engagement with the contact arm when the contact arm is not in an OFF position. Therefore, unintentional engagement of the lock member may be avoided. As a result, a feeding operation of the pusher for driven members is not inhibited. In other publication, an engaged state of the lock member is avoided, as the lock member is elastically deformed when a shock is applied to the contact arm, etc. The lock member is incorporated separately from the pusher in a magazine of half-split structure made of resin.

As disclosed in the publications, a rechargeable driving tool may, for example, have a driving nose and a housing for a driver wind-up portion configured in a separate structure. This structure has a problem that it is difficult to secure enough space to adopt a rotary lock member. In addition, because the magazine is made of a drawn aluminum material for durability, it is difficult to apply the lock member to this structure. There is a need for a driving operation restricting structure that does not require space for a conventional rotary type lock member and can be easily applied to a magazine made of drawn aluminum material.

### SUMMARY

The present disclosure relates to a driving tool that may include, for example, a driver configured to drive a driven member into a workpiece and a lift mechanism that returns the driver in a direction opposite to the driving direction of the driven member. The driving tool may include a contact arm that is pressed against the workpiece and moves with respect to the tool body to allow the driver's driving operation, and a magazine in which the driven members are loaded. The driving tool may have a pusher that is movable within the magazine and that pushes the driven members toward a driving channel of the driver. In addition, the driving tool has a lock member that is displaceable in the pusher along a plane that includes a movement direction of the pusher. The lock member enters a movement path of the contact arm and restricts the movement of the contact arm.

The movement of the contact arm is restricted when the lock member enters the movement path of the contact arm. By restricting the movement of the contact arm, for example, driving operations such as idle striking may be restricted. The lock member is displaceable in the pusher along a plane that includes the movement direction of the pusher, which means that the lock member does not require a space required for conventional rotary-type lock members and is easily incorporated into a magazine that is for example may be made of a drawn aluminum material.

### BRIEF DESCRIPTION OF THE DRAWINGS

FIG. 1 is a left side view of a driving tool.

FIG. 2 is a front view of an interior structure of a tool body and a lift mechanism as viewed from a direction of an arrow II in FIG. 1. This view illustrates a driver in a stand-by position.

FIG. 3 is a left side view of the driving tool. In this figure, a driving nose is shown in vertical cross-section.

FIG. 4 is a front view of an interior structure of the tool body and lift mechanism. This view shows the driver at a top dead center.

FIG. 5 is a left side view of the driving tool. This view shows driven members being fed into a driving channel.

FIG. 6 is a front view of the driving nose. This view shows a state in which the driver has reached a downward motion end and a driven member is driven into a workpiece.

FIG. 7 is a left side view of the driving nose and a pusher. This view shows a state in which a lock member is not entering a movement path of a contact arm.

FIG. 8 is a left side view of the driving nose and the pusher. This view shows a state in which the lock member is entering the movement path of the contact arm.

FIG. 9 is a cross-sectional view taken along a line IX-IX in FIG. 7, and is a vertical cross sectional view of a magazine.

FIG. 10 is a perspective view of a pusher unit.

FIG. 11 is a left side view of the pusher unit.

FIG. 12 is a cross-sectional view taken along a line XII-XII in FIG. 11.

FIG. 13 is a left side view of the driving tool according to a second example.

FIG. 14 is a left side view of an idle striking prevention mechanism according to the second example. This figure shows a state in which the last driven member has been fed into the driving channel, immediately before the idle striking prevention is activated.

FIG. 15 is a left side view of the driving tool according to a third example.

FIG. 16 is a left side view of the pusher and its surroundings for the third example.

FIG. 17 is a perspective view of the pusher according to the third example. In this figure, a holder is shown in a vertical cross-section along a feed direction.

FIG. 18 is a left side view showing an operating state of the lock member. This figure shows a state when a remaining number of driven members is above a certain number while a contact portion of the lock member is away from a contact surface of the tool body.

FIG. 19 is a left side view illustrating an operating state of the lock member. This figure shows a state in which the contact portion of the lock member is in contact with the contact surface of the tool body.

FIG. 20 is a left side view illustrating the operating state of the lock member. This figure shows a state when the remaining driven members have reached the certain number while an engaging portion of the lock member has entered the movement path of the contact arm.

### DETAILED DESCRIPTION

According to an aspect of the present disclosure, when a driven member pushed by a pusher encounters a lateral side of an end in a driving direction of a driver in a stand-by position, unintentional driving operation is prevented.

According to another aspect of the present disclosure, the pusher pushes and feed (load) the driven member into a driving channel of the driver during which the driver reaches to a top dead center from the stand-by position. Therefore, the driven member is fed into the driving channel immediately before the driver reaches the top dead center, and then the driver moves through the driving channel to perform the driving operation.

According to another aspect of the present disclosure, the lock member is provided and displaceable in the pusher in a direction parallel to the movement direction of the pusher making the lock member compactly incorporated into the pusher.

According to another aspect of the present disclosure, the lock member is displaced to a retracted position when its distal end face butted against the contact arm. In this configuration, the lock member does not enter and interfere with the movement path of the contact arm.

According to another aspect of the present disclosure, the pusher has a guide portion capable of being moveable to support the lock member and a removal preventing member configured to prevent the lock member from being removed from the guide portion. Accordingly, the lock member is non-removably supported to the pusher.

According to another aspect of the present disclosure, the lock member is a plate-like member having a support portion located within the guide portion and an engaging portion located outside the guide portion. The engaging portion is bent against the support portion to extend along a plane across the guide portion. As the engaging portion enters the movement path of the contact arm, the lock member with a simple and inexpensive configuration may be compactly incorporated without requiring large space.

According to another aspect of the present disclosure, the lock member is provided and displaceable on the pusher in a direction different from the movement direction of the pusher making the lock member compactly incorporated into the pusher.

According to another aspect of the present disclosure, the lock member has an engaging portion at a bottom, which is the driving direction, and a contact portion at a top. The contact portion is restricted from being displaced upward by a restricting surface of the tool body. The engaging portion enters the movement path of the contact arm. Accordingly, the upper contact portion is restricted from being displaced upward by the restricting surface of the tool body, thereby causing the displacement of the lock member to allow the engaging portion to enter the movement path of the contact arm.

According to another aspect of the present disclosure, as the contact portion is a part protruding toward the tool body, it encounters the restricting surface of the tool body to ensure that upward displacement is restricted.

According to another aspect of the present disclosure, as the lock member rotates along a plane that includes the movement direction of the pusher, it has capability of being displaced in a more compact space with respect to the movement direction of the pusher.

According to another aspect of the present disclosure, a pusher biasing member to bias the pusher toward the driving channel is provided, and a lock biasing member to bias the lock member in a direction projecting from the pusher is provided. For example, a biasing force of the lock biasing member is weaker than that of the pusher biasing member. Therefore, even when the lock member is butted against the contact arm, the pushing force of the pusher in the feed direction to the driven member is reliably exerted. This ensures that the driven members are reliably fed.

According to another aspect of the present disclosure, the pusher has a holder in which a lock member is provided and displaceable. The pusher further has a pusher piece that is rotatably provided on the holder and is in contact with the driven member. Accordingly, the pusher moves when the pusher piece is in contact with the driven member, thereby loading the driven member into the driving channel.

According to another aspect of the present disclosure, the driven member is fed toward the driving direction as the driven member comes closer to the driving channel. Therefore, for angle-type driving tools in which the driven member feed direction is inclined to the driving direction, a lock member compactly incorporated in the pusher provides reliable idle striking prevention.

According to another aspect of the present disclosure, the driver has a coupled piston, and the gas pressure generated by the movement of the piston causes the driver to perform a driving operation. Therefore, each of the above aspects is applicable to a driving tool in a configuration in which the driving operation is performed using gas pressure as a thrust force.

### EXAMPLES

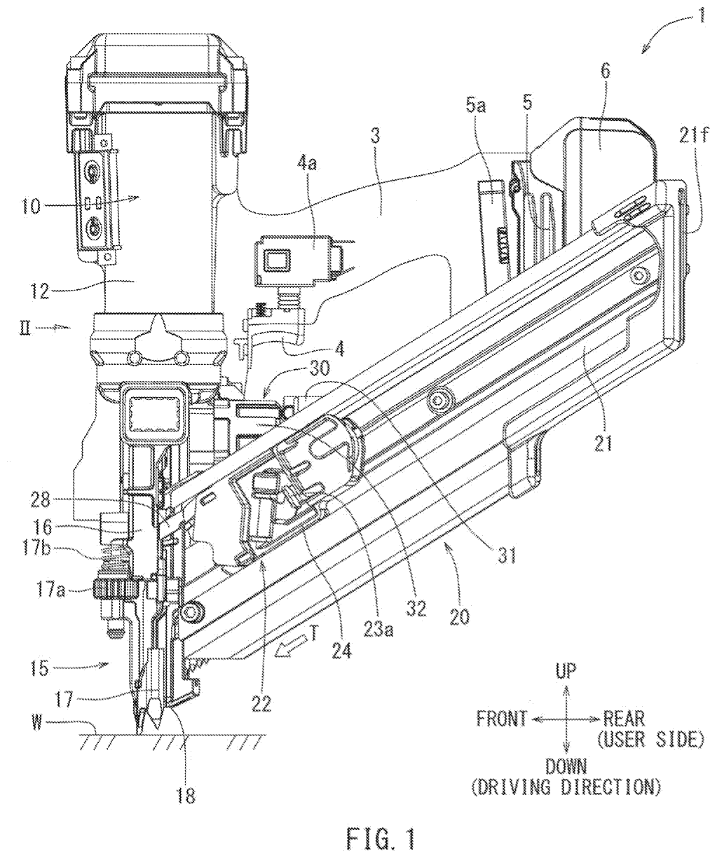

An example of the present disclosure is a gas spring type driving tool that utilizes a gas pressure in a pressure accumulation chamber above a cylinder as a thrust force for driving driven members t. For example, rod-shaped nails may be used as the driven members t. In the following description, a driving direction of the driven member t is determined as a downward direction and a counter-driving direction is determined as an upward direction. A user of the driving tool 1 is positioned on a right side (grip 3 side) of the driving tool 1 in FIG. 1. A side in front of the user is a rear direction (user side), and an opposite side of the user side is a front direction. Left and right directions are determined based on the user grasping the grip 3.

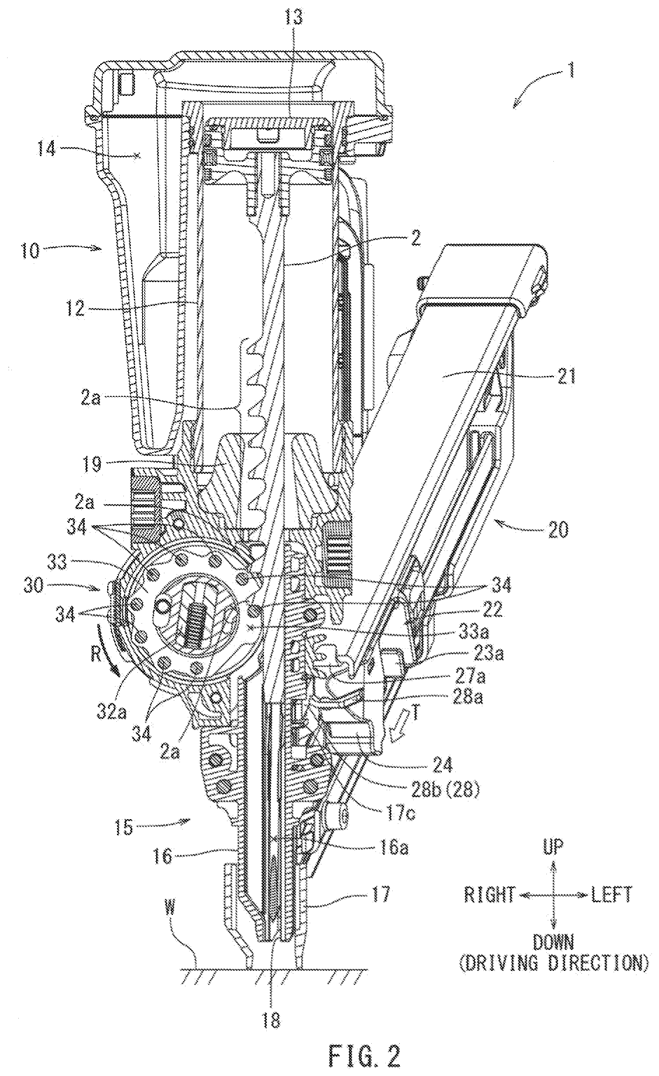

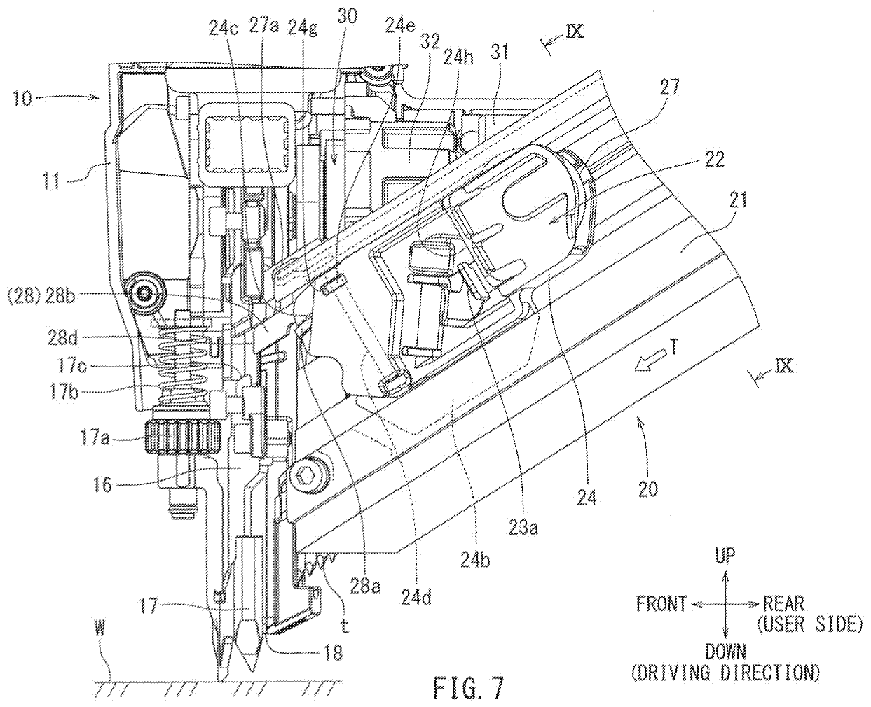

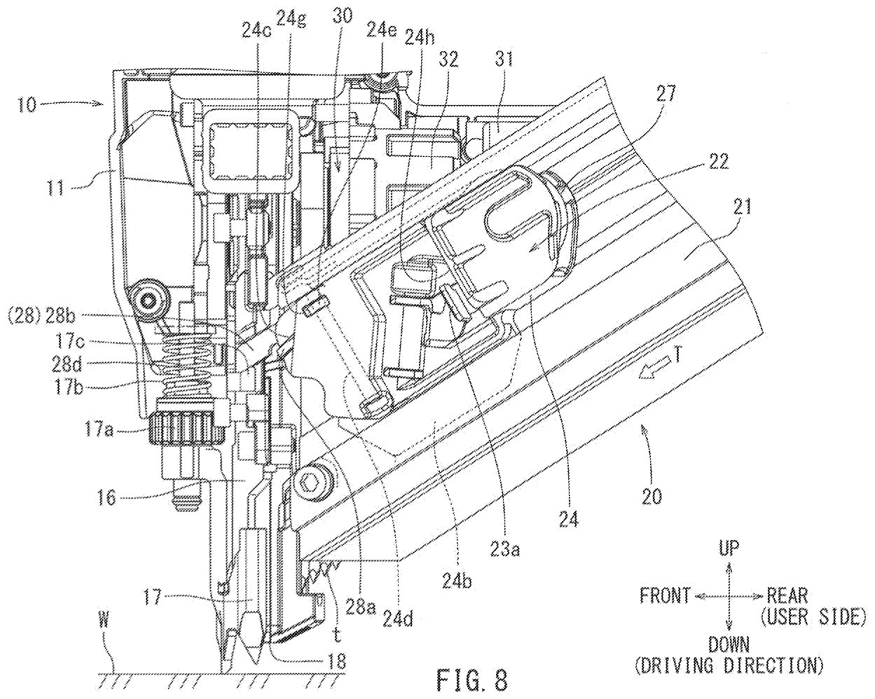

As shown in FIGS. 1 and 2, the driving tool 1 has a tool body 10. The tool body 10 has a cylinder 12 accommodated in a body housing 11 (see FIGS. 7 and 8), which is not shown in FIGS. 1 and 2. A piston 13 is housed in the cylinder 12 so as to be reciprocally movable up and down. An upper portion of the cylinder 12 above the piston 13 communicates a pressure accumulation chamber 14. The pressure accumulation chamber 14 is filled with compressed gas, such as air. The gas pressure in the pressure accumulation chamber 14 acts as a thrust force on a top of the piston 13 to move downward.

A driving nose 15 is provided at a lower part of the tool body 10. The driving nose 15 has a driver guide 16 and a contact arm 17. An inner circumferential side of the driver guide 16 defines a driving channel 16a. The driving channel 16a communicates an inner circumferential side of the cylinder 12. A long driver 2 enters the driving channel 16a so as to be reciprocally movable up and down.

The contact arm 17 is supported displaceable upward and downward around the driver guide 16. The contact arm 17 extends upward and downward around a lower end (ejection port 18) of the driver guide 16. The contact arm 17 is biased to a lower OFF position by a compression spring 17b. In the OFF position, the lower end of the contact arm 17 is located below the ejection port 18. The contact arm 17 is pressed against the workpiece W to move relatively upward (ON operation), thereby allowing a pull-operation of a switch lever 4 to be effective. A dial 17a for adjusting a driving depth is provided below the compression spring 17b. By rotating the dial 17a, the OFF position of the contact arm 17 may be displaced upward and downward. This changes a stroke of the contact arm 17 to change a position of the ejection port 18 with respect to the workpiece W during the on operation. As a result, the depth of the driven member t to the workpiece W is switched.

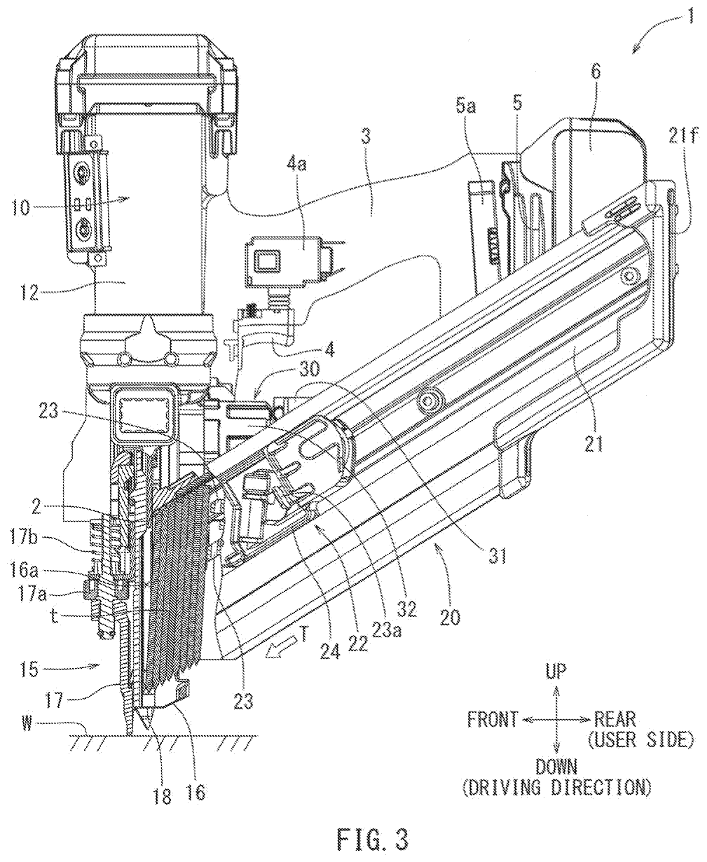

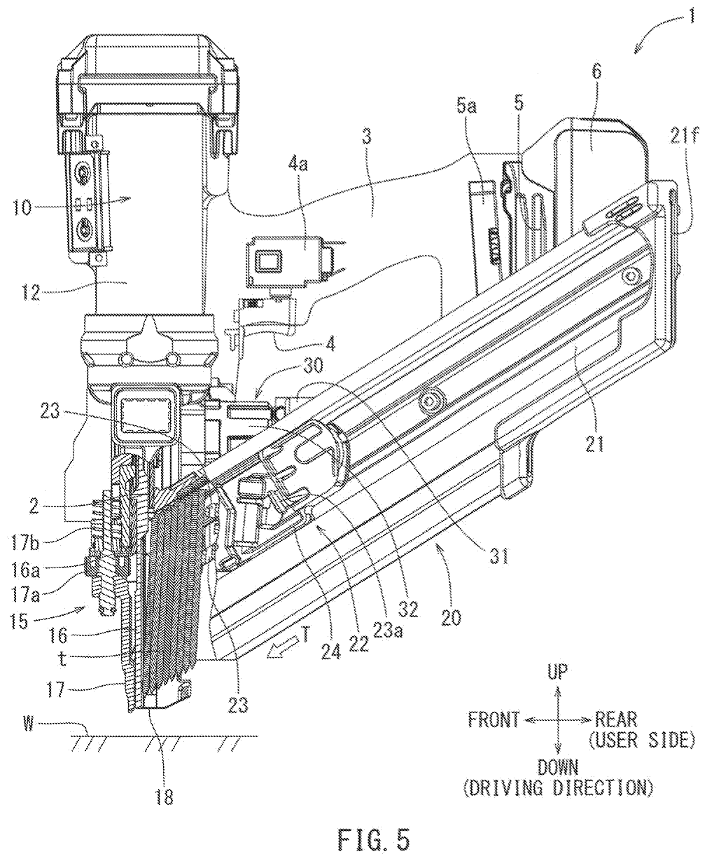

A magazine 20 is coupled to a rear side of the driving nose 15. As shown in FIGS. 3 and 5, a number of driven members t are loaded into the magazine 20. One driven member t fed from inside the magazine 20 into the driving channel 16a is struck by the downwardly moving driver 2.

A grip 3 is provided on a rear side of the tool body 10 for the user to grasp. On a front lower side of the grip 3, a switch lever 4 is provided for activation, which is operated by the user pulling it with his/her fingertips. A switch body 4a is installed above the switch lever 4. When the switch lever 4 is pulled upward, the switch body 4a turns ON. When the switch body 4a is turned ON, power is supplied to a lift mechanism 30, which will be described below.

A battery mount 5 is located at a rear part of the grip 3. A battery pack 6 is attached to a rear side of the battery mount 5. The battery pack 6 is slidably moved in an up and down direction to be attached to and removed from the battery mount 5. The battery pack 6 is removed from the battery mount 5 and charged with a separately prepared charger to be allowed to be repeatedly used. The battery pack 6 is versatile enough to be used as a power source for other power tools. An electric motor 31 of the lift mechanism 30 operates with the electric power of the battery pack 6 as a power source.

As shown in FIG. 1, a flat-plate shaped controller 5a is accommodated within the battery mount 5. Operation can be started by turning on the switch lever 4 and by moving of the contact arm 17. The controller 5a mainly controls an operation of the electric motor 31 of the lift mechanism 30.

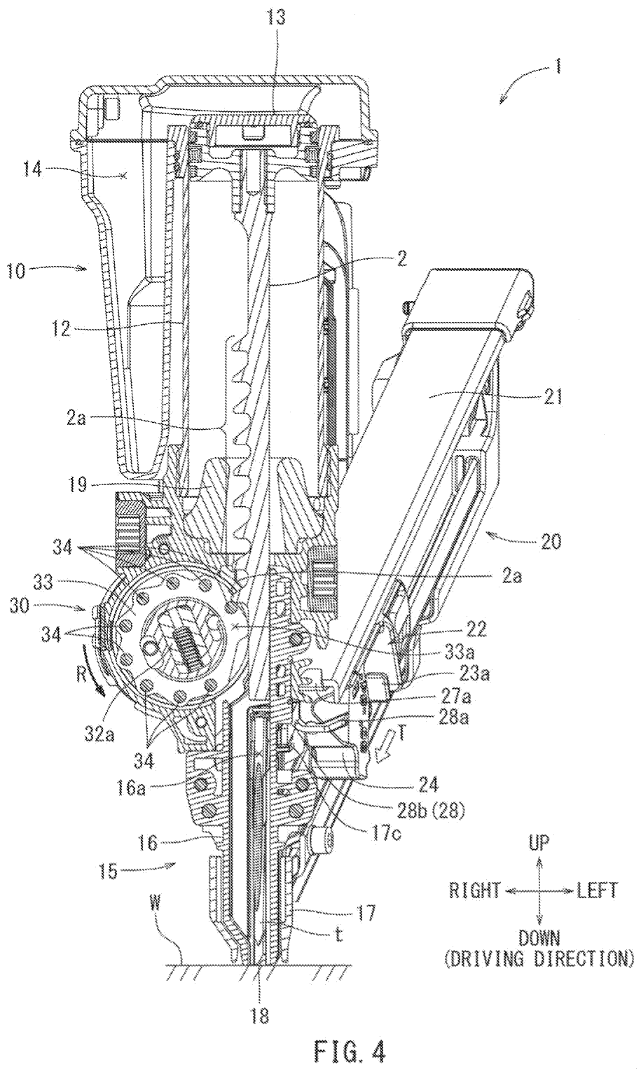

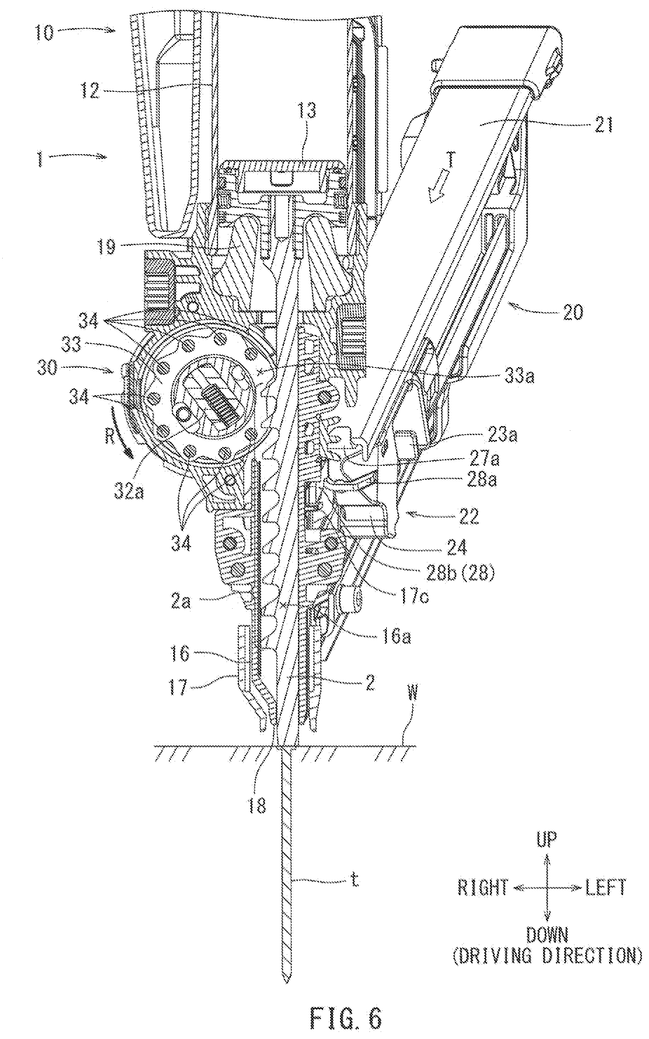

As shown in FIG. 4, a downward motion end damper 19 is disposed below the cylinder 12 to absorb the shock of the piston 13 at the downward motion end. A driver 2 is coupled to a center of a lower surface of the piston 13. The driver 2 extends long downward from the lower surface of the piston 13. A leading end (lower side) of the driver 2 in the driving direction passes through the inner circumferential side of the downward motion end damper 19 and enters the driving channel 16a. The driver 2 moves downward through the driving channel 16a by the gas pressure of the pressure accumulation chamber 14 acting on the upper surface of the piston 13. The leading end (lower end) of the driver 2 moving downward through the driving channel 16a strikes one driven member t fed into the driving channel 16a. As shown in FIG. 6, when the piston 13 reaches the downward motion end, the driven member t is ejected from the ejection port 18. The ejected driven member t is driven into the workpiece W.

As shown in FIGS. 1, 3, and 5, a lift mechanism 30 is provided below the grip 3. The lift mechanism 30 has an electric motor 31 as a drive source. One lifter 33 is supported in front of the electric motor 31 via a reduction gear train 32. The driver 2 and piston 13, which have reached the downward motion end, are returned by the lift mechanism 30 to the upper stand-by position (opposite to the driving direction of the driven member t). Details of the lifter 33 are shown in FIGS. 2, 4, and 6. The lifter 33 is supported on an output shaft 32a of the reduction gear train 32. The lifter 33 rotates in a direction indicated by an arrow R in FIGS. 2, 4, and 6 (counterclockwise direction in the figures). This causes the driver 2 to return upward (counter-driving direction).

As shown in FIGS. 2, 4, and 6, a plurality (nine in the figure) of engaging portions 2a are provided on a right side of the driver 2. Each engaging portion 2a has a rack-tooth shape projecting to the right. The plurality of engaging portions 2a are arranged at constant intervals in a longitudinal (up-down direction) direction of the driver 2. The lifter 33 of the lift mechanism 30 is sequentially engaged with the plurality of engaging portions 2a.

The lifter 33 is disposed on the right side of the driver 2. The lifter 33 has a plurality (e.g., nine) of engagement pins 34 that are sequentially engaged with the engaging portions 2a of the driver 2. A cylindrical shaft member is used for each engagement pin 34. The plurality of engagement pins 34 are arranged at constant intervals along an outer circumferential edge of the lifter 33. Between the first and last engagement pins 34 in the rotational direction indicated by the arrow R, a large interval is formed in the rotational direction (a relief area 33a where there is no engagement pin 3). When this relief area 33a is directed toward the driver 2, the lifter 33 is disengaged from the engaging portions 2a of the driver 2. FIG. 4 shows a state in which the driver 2 reached the top dead center immediately before the engaged state is released. FIG. 6 shows a driving state when the engaged state of the driver 2 is released.

The activation of the electric motor 31 causes the lifter 33 to rotate in the direction indicated by an arrow R. As shown in FIG. 6, after driver 2 has reached the downward motion end, the rotation of lifter 33 in the direction indicated by the arrow R causes driver 2 to return upward as the engaging pins 34 are sequentially engaged with the engaging portions 2a of the driver 2 from below. As the piston 13 is returned upward by the lift mechanism 30, the gas pressure in the pressure accumulation chamber 14 is increased. When the driver 2 is returned to the stand-by position shown in FIG. 2, the electric motor 31 stops to end the series of driving operations.

When the switch lever 4 is pulled again, the lift mechanism 30 restarts. This causes the lifter 33 to begin rotating in the direction indicated by the arrow R to lift the driver 2 and piston 13 further upward from the stand-by position. FIG. 4 shows the driver 2 and the piston 13 lifted to an upward motion end position.

After the driver 2 and the piston 13 have reached the upward motion end position, the lifter 33 continues to rotate in the direction indicated by the arrow R to disengage the lifter 33 from the engaging portions 2a of the driver 2. As a result, the relief area 33a of the lifter 33 is directed toward the driver 2, and the driver 2 is moved downward by the gas pressure of the pressure accumulation chamber 14 acting on the piston 13. As the driver 2 moves downward through the driving channel 16a, the driven member t is struck and driven into the workpiece W. FIG. 6 shows a state in which the piston 13 has reached the downward motion end and the driven member t is driven into the workpiece W.

The magazine 20 is coupled to the rear side of the driver guide 16. The magazine 20 has a long magazine body 21 made of drawn aluminum material. As shown in FIGS. 1 and 2, the magazine body 21 extends from the rear side of the driver guide 16 in a direction diagonally inclined leftward and upward. As a result, the magazine body 21 extends with a length that passes over the left side of the battery mount 5. A number of driven members t temporarily fixed in parallel are loaded inside the magazine body 21. As indicated by void arrows in the figure, the longitudinal direction of the magazine body 21 and the direction toward the driving channel 16a correspond to a feed direction T of the driven members t.

Thus, the feed direction T of the driven members t relative to the driving channel 16a is inclined to the extending direction of the driving channel 16a (the driving direction of the driver 2). Therefore, the driven members t are fed to displace in the driving direction as they approach the driving channel 16a. The driving tool 1 equipped with this angle-type magazine 20 is also referred to as an angle nailer. The angle type magazine 20 is usually applied when the driven member t to be housed is a nail with a head ta (e.g., a brad nail). Since the magazine 20 accommodates a number of driven members t that are interconnected with their heads ta shifted in an axial direction of a shaft portion tb, the feed direction T (longitudinal direction of the magazine body 21) is inclined to the driving direction (nail axial direction).

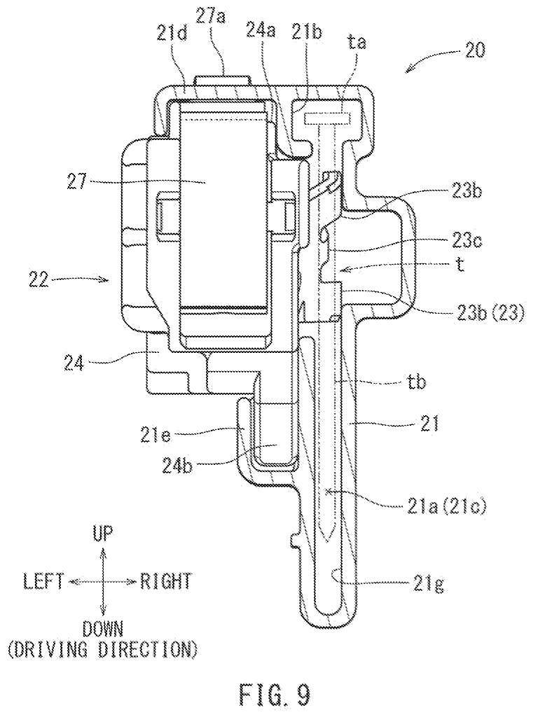

As shown in FIGS. 1, 3, and 5, a loading port 21f opens at a rear part of the magazine body 21. A number of driven members t temporarily fixed in a flat plate shape are loaded into the housing 21a of the magazine body 21 through the loading port 21f. As shown in FIG. 9, the housing 21a is a space in a form of a flat plate that can accommodate the driven members t along the up-down direction, and the housing 21a has a head housing 21b that holds the heads ta of the driven members t at the top. A shaft housing 21c extends downward from the head housing 21b. Shaft portions tb of the driven members t are accommodated in the shaft housing 21c. Driven members t with shaft portions tb having different length are housed in the housing 21a with their heads ta at the common position.

A pusher 22 is held at a left side of the housing 21a. The pusher 22 has a pusher claw 23 that pushes the driven members t toward the driving channel 16a and a holder 24 that supports the pusher claw 23. The holder 24 has guide edges 24a, 24b on its upper and lower surfaces. Upper and lower guide rails 21d, 21e are provided on a left side of the magazine body 21. The upper guide edge 24a is held by the upper guide rail 21d while the lower guide edge 24b is held by the lower guide rail 21e. This allows the holder 24 to be slidably supported along a longitudinal direction of the magazine body 21 (feed direction T and counter-feed direction of the driven members t).

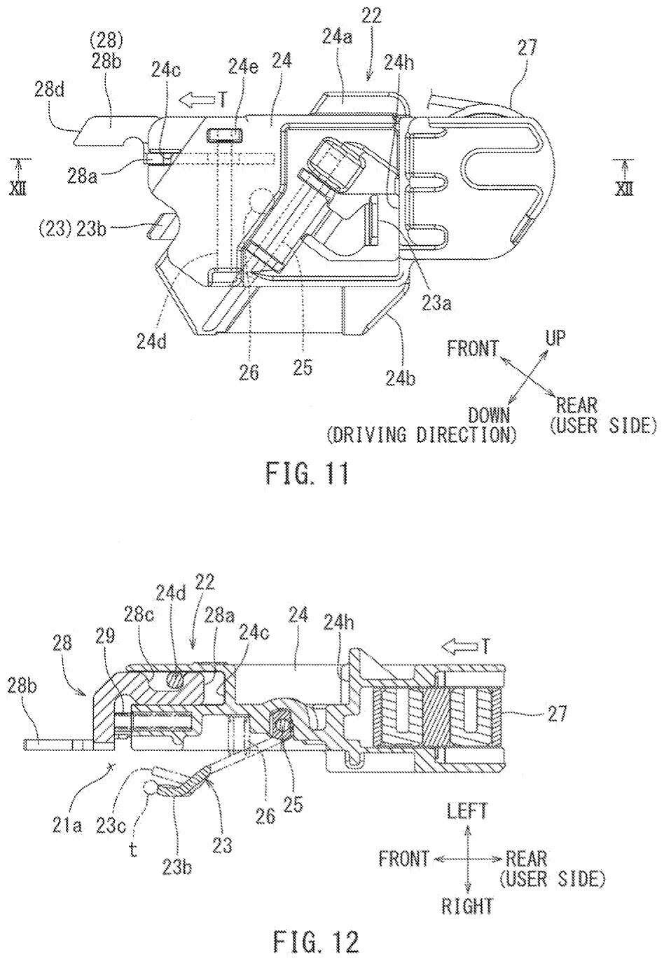

As shown in FIGS. 11 and 12, the pusher claw 23 is pivotably supported by the holder 24 to the left and right via a support shaft 25. Two pusher pieces 23b are provided at an end of the pusher claw 23 in the feed direction. The pusher claw 23 is biased by a compression spring 26 in a direction (counterclockwise in FIG. 12) to allow the pusher pieces 23b to meet a bottom portion 21g (see FIG. 9) of the housing 21a.

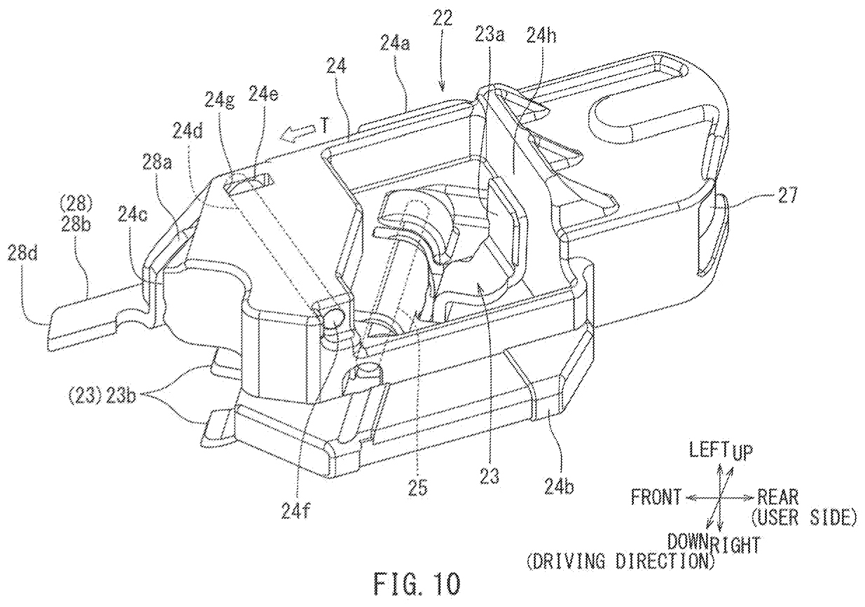

As shown in FIGS. 10 and 11, a lever 23a is provided at a rear of the pusher claw 23. The pusher claw 23 can be rotated as the user tilts and operates the lever 23a with his/her fingertip. By tilting the lever 23a backward against the compression spring 26, a tip (pusher piece 23b) of the pusher pawl 23 can be displaced in a direction to be lifted (to the left) from the bottom 21g of the housing 21a. This allows the driven member t loaded from the loading port 21f of the magazine body 21 to pass through the right side of the pusher claw 23 and shift to the front side (driving channel 16a side) in the feed direction. When the tilting operation of the lever 23a is released, the pusher piece 23b is returned to a state in which the pusher piece 23b abuts a bottom 21g of the housing 21a by the biasing force of the compression spring 26 and is engaged with the driven member t at the rear end in the driving direction. A restricting claw 23c is provided between the two pusher pieces 23b to restrict the driven member t from lifting to the left.

A pusher biasing member 27 configured to bias the pusher 22 toward the driving channel 16a is provided at a rear portion of the holder 24 is. A coiled leaf spring may be used for the pusher biasing member 27. One end (center side of the winding) of the pusher biasing member 27 is coupled to the holder 24. As shown in FIG. 7, the other end 27a of the pusher biasing member 27 is hooked and coupled to the front end of the magazine body 21. The pusher 22 slides in the counter-feed direction while the pusher biasing member 27 is extended. By sliding the pusher 22 in the counter-feed direction against the pusher biasing member 27 while tilting the lever 23a backward against the compression spring 26 as described above, the driven members t loaded from the loading port 21f pass through the right side of the pusher claw 23 to be shifted forward in the feed direction.

A finger hook 24h is provided at the left side of the holder 24. A user can easily slide the pusher 22 in the counter-feed direction by hooking his/her finger on the finger hook 24h. The finger hook 24h is arranged rear side of the lever 23a. When sliding the pusher 22 in the counter-feed direction, the fingertip can be hooked on both the lever 23a and the finger hook 24h. This facilitates to slide the pusher 22 in the counter-feed direction with the pusher piece 23b of the pusher claw 23 lifted from the bottom 21g of the housing 21a.

When the backward sliding operation of pusher 22 is released, the pusher 22 is biased toward the front side in the feed direction by the biasing force of the pusher biasing member 27. As a result, all loaded driven members t are pushed in the feed direction by the pusher claws 23 engaged with the driven member t at the rear end of the feed direction. The biasing force of the pusher biasing member 27 corresponds to a force of the pusher claw 23 pushing the driven members t.

The pusher 22 is provided with one lock member 28. The lock member 28 is manufactured by bending a plate-like material. The lock member 28 has a support portion 28a and an engaging portion 28b. The support portion 28a and the engaging portion 28b are bent so that their plane directions are orthogonal to each other. As shown in FIG. 12, the support portion 28a is positioned within the guide portion 24c provided to the holder 24. Thereby, the lock member 28 is supported by the holder 24 so as to be displaceable along a plane that includes the movement direction of the pusher 22 (the driving direction T of the driven member t).

The support portion 28a is provided with a recess 28c. A removal preventing member 24d provided on the guide portion 24c enters the recess 28c. In this example, a shaft member is used for the removal preventing member 24d. The removal preventing member 24d is supported in the thickness direction of the lock member 28. The removal preventing member 24d restricts the lock member 28 from being removed from the guide portion 24c. To the extent that the removal preventing member 24d can be relatively displaced within the recess 28c, the lock member 28 is supported displaceable relative to the holder 24 in the feed direction T and in the counter-feed direction.

As shown in FIGS. 10 and 11, an elastic ring 24e is attached to the removal preventing member 24d. This prevents the removal preventing member 24d from being removed from the support hole 24f. The elastic ring 24e is positioned within the mounting hole 24g, so that it is positioned almost simultaneously with the support hole 24f. When the lock member 28 is assembled to the holder 24, the elastic ring 24e is attached to the removal preventing member 24d by inserting the removal preventing member 24d into the support hole 24f with the elastic ring 24e positioned in the mounting hole 24g. This facilitates to assemble the removal preventing member 24d to the holder 24.

The engaging portion 28b of the lock member 28 is located outside of the guide portion 24c. The engaging portion 28b extends along a plane across the guide portion 24c. A distal end face 28d of the lock member 28 is formed in a distal end face that is substantially parallel to the driving direction of the driven member t and the movement direction (up-down direction) of the contact arm 17. The distal end face 28d of the lock member 28 is therefore inclined to the driving direction T of the driven member t (sliding direction of the lock member 28).

As shown in FIG. 12, a lock biasing member 29 is interposed between the lock member 28 and the holder 24. A compression spring may be used for the lock biasing member 29. The lock biasing member 29 biases the lock member 28 against the holder 24 in a direction projecting to the feed direction. Therefore, the lock member 28 is displaceable in the counter-feed direction against the lock biasing member 29.

The biasing force of the lock biasing member 29 is weaker than the biasing force of the pusher biasing member 27. Therefore, for example, even when the lock member 28 is abutted against the contact arm 17, the pusher 22 moves in the feed direction by retracting the lock member 28 against the lock biasing member 29. The biasing force of the pusher biasing member 27 and the lock member 28 is appropriately set such that the biasing force of the lock biasing member 29 does not disturb the force of the pusher claw 23 pushing the driven member t.

The lock member 28 provided on the pusher 22 has an idle striking prevention function that restricts the driving operation of the tool body 10 when the remaining number of the driven members t in the magazine 20 has reached a certain number. In the stand-by position of the driver 2 shown in FIGS. 1 to 3, the head ta of the driven member t pushed by the pusher 22 meets the lateral side of the end (lower end) of the driver 2 in the driving direction. Therefore, as shown in FIG. 3, in the standby state of the driver 2, the driven member t is not fed into the driving channel 16a. Also, at this stage, as shown in FIGS. 1 and 7, the lock member 28 of the pusher 22 has not entered the movement path of the contact arm 17. Therefore, the contact arm 17 is in a state in which the contact arm 17 can be turned ON and the driving operation is allowed.

As shown in FIGS. 4 and 5, when the contact arm 17 and the switch lever 4 are turned ON, the lift mechanism 30 is activated such that the driver 2 shifts from the stand-by position to the top dead center. While the driver 2 shifts from the stand-by position to the top dead center, the state in which the head ta of the driven member t is in contact with the lower end of the driver 2 is released. This causes the driven member t to be pushed by the pusher 22 and fed into the driving channel 16a.

As shown in FIG. 8, when the remaining number of the driven members t in the magazine 20 reaches a predetermined fixed number (e.g., zero or a few), the idle striking prevention is activated. When a driven member t (the last driven member t) immediately before the idle striking prevention is activated is fed into the driving channel 16a (see FIG. 3), the distal end face 28d of the lock member 28 is abutted from the side against the contact arm 17, which moved upward by the ON operation. The abutted lock member 28 is retracted against the lock biasing member 29 (see FIG. 12). The pusher 22 is thus shifted in the feed direction by the biasing force of the pusher biasing member 27. As a result, the last driven member t is pushed by the pusher claw 23 with sufficient force (biasing force of the pusher biasing member 27) and is reliably fed into the driving channel 16a.

As shown in FIG. 4, after the driver 2 has reached the top dead center, the lifter 33 continues to rotate in the direction indicated by the arrow R, thereby disengaging the engaging pin 34 from the engaging portion 2a of the driver 2. As a result, the gas pressure in the pressure accumulation chamber 14 causes the piston 13 and driver 2 to move downward to strike the last driven member t. As shown in FIG. 6, when driver 2 reaches the downward motion end, the driven member t is driven into the workpiece W.

As shown in FIG. 6, after the driver 2 has reached the downward motion end, the lifter 33 continues to rotate in the direction indicated by the arrow R as shown in FIG. 2, returning the driver 2 to the stand-by position. The contact arm 17 returns to the OFF position by the reaction during driving or by releasing the ON operation of the user after driving. As shown in FIG. 8, the distal end face 28d of the lock member 28, which is abutted against the contact arm 17 from the side, is formed in a plane parallel to the movement direction of the contact arm 17. Therefore, during the process of returning the contact arm 17 to the OFF position, the lock member 28 is pushed back smoothly in the counter-feed direction by the contact arm 17. This prevents the lock member 28 from entering the movement path of the contact arm 17. Accordingly, in this example, the lock member 28 slides in the counter-feed direction to avoid being engaged with the contact arm 17 in the process of returning. As a result, the lock member 28 can be retracted in a more limited space compared to the conventional configuration in which the lock member 28 is retracted by a rotating motion.

As shown in FIG. 8, when the contact arm 17 is returned to the OFF position, the lock member 28 is pushed out by the lock biasing member 29 and enters above the locking portion 17c of the contact arm 17. As a result, the ON operation (upward movement) of the contact arm 17 is restricted. When the contact arm 17 is returned to the OFF position and the driver 2 is returned to the stand-by position, the head ta of the next driven member t is contacted from the side against the lower end of the driver 2 and is not yet fed into the driving channel 16a as described above.

When the remaining driven members t in the magazine 20 reach a certain number, the lock member 28 provided in the pusher 22 is above the locking portion 17c of the contact arm 17 and enters into the movement path of the contact arm 17. As a result, the ON operation of the contact arm 17 is restricted, thereby preventing idle striking.

According to the above-described first example, the ON operation of the contact arm 17 is restricted as the lock member 28 enters the movement path of the contact arm 17 to prevent idle striking. The lock member 28 is provided on the pusher 22 to be displaceable along a plane that includes the movement direction of the pusher 22 (the feed direction T of the driven member t).

Therefore, the lock member 28 can be movably incorporated in a limited space without requiring a large space like a conventional rotary type lock member. In this aspect, the illustrated idle striking prevention mechanism (lock member 28) can be more easily incorporated into the gas spring type driving tool 1, for which a large space cannot be ensured, for example, when the lift mechanism 30 is disposed around the driving channel 16a.

Furthermore, a lock member 28 for restricting the movement of the contact arm 17 is provided in the pusher 22 to prevent idle striking. This makes it easier to incorporate the lock member 28 into the magazine compared to the conventional configuration in which the lock member is incorporated into the magazine separately from the pusher. In this aspect, the illustrated idle striking prevention mechanism (lock member 28) can be more easily incorporated into the magazine 20 having the magazine body 21 made of drawn aluminum material.

According to the first example, the driven member t pushed by the pusher 22 abuts the lateral side of the end of the driver 2 in the driving direction at the stand-by position. Thus, unintentional driving operation may be prevented.

According to the first example, the driven member t is pushed by the pusher 22 and fed into the driving channel 16a while the driver 2 reaches the top dead center from the stand-by position. Therefore, the driven member is fed into the driving channel 16a immediately before the driver 2 reaches the top dead center, and then the driver 2 moves through the driving channel 16a to perform the driving operation.

According to the first example, the lock member 28 is provided displaceable in the holder 24 of the pusher 22 in a direction parallel to the movement direction of the pusher 22. Thus, the lock member 28 may be compactly incorporated into the pusher 22.

According to the first example, the lock member 28 is displaced to a retracted position when the distal end face 28d of the engaging portion 28b is butted against and met the contact arm 17. This prevents the lock member 28 from entering into the movement path of the contact arm 17 to allow the contact arm 17 to move to the OFF position.

According to the first example, as shown in FIG. 12, the pusher 22 is provided with a guide portion 24c configured to movably support the lock member 28 and a removal preventing member 24d configured to prevent the lock member 28 from being removed from the guide portion 24c. As a result, the lock member 28 is non-removably supported to the pusher 22.

According to the first example, as shown in FIG. 12, the lock member 28 is a plate-like member, having a support portion 28a located within the guide portion 24c and an engaging portion 28b located outside the guide portion 24c and bent against the support portion 28a to extend along a plane across the guide portion 24c. The engaging portion 28b enters the movement path of the contact arm 17 to prevent idle striking. Thus, the simple and inexpensive configuration of the lock member 28 is compactly incorporated into the magazine 20 without requiring a large space.

According to the first example, as shown in FIG. 12, a pusher biasing member 27 configured to bias the pusher 22 toward the driving channel 16a and a lock biasing member 29 configured to bias the lock member 28 in the direction of projecting from the pusher 22 are provided. The biasing force of the lock biasing member 29 is smaller or weaker than the biasing force of the pusher biasing member 27. Therefore, even when the engaging portion 28b of the lock member 28 is pressed against the contact arm 17, the pushing force in the feed direction of the pusher 22 against the driven member t is reliably exerted. As a result, the driven member t is reliably fed.

According to the first example, as shown in FIG. 12, the pusher 22 has a holder 24 in which lock member 28 is displaceably provided, and a pusher piece 23b that is rotatably provided on the holder 24 and comes in contact with the driven member t. Accordingly, the pusher 22 moves with the pusher piece 23b in contact with the driven member t to feed the driven member t toward the driving channel 16a.

According to the first example, as shown in FIG. 6, the driver 2 has a piston 13 coupled to it, and the gas pressure generated by the movement of the piston 13 causes the driver 2 to perform the driving operation. Therefore, each of the above examples is applicable to a gas spring type driving tool 1 that uses gas pressure as a thrust force to perform the driving operation.

Various modifications may be made to the first example. For example, the removal preventing member 24d, which restricts the range of movement of the lock member 28, is a shaft member as shown in FIG. 12. Instead, the removal preventing member may be configured to use a protrusion. By having the projection protrude into the recess 28c, the lock member 28 can be restricted from being removed from the guide portion 24c.

The removal preventing member 24d may be replaced by a spring pin. By press-fitting the spring pin into the support hole 24f, the elastic ring 24e and mounting hole 24g shown in FIG. 10 may be omitted.

The lock biasing member 29 configured to bias the lock member 28 toward the driving channel 16a may be, for example, a compression spring as shown in FIG. 12. Alternatively, the lock biasing member may be configured to have a tension spring, leaf spring, or urethane rubber.

The support portion 28a and engaging portion 28b of the lock member 28 shown in FIG. 12 are bent so that their plane directions are orthogonal to each other. Alternatively, the bending process may be omitted, and the entire lock member may have the same flat plate shape. It may also be configured to use a round rod-shaped lock member.

The support portion 28a shown in FIG. 12 is inserted into the guide portion 24c to slidably support the lock member 28 along the feed direction T of the driven member t. Alternatively, the support portion may be configured to be slidably supported using, for example, two slide bars.

The compression spring 26 shown in FIG. 12 biases the pusher piece 23b in a direction to enter the housing 21a. Instead of the compression spring 26, a tension spring or torsion spring may be used to bias the pusher claw 23.

The pusher biasing member 27 configured to bias the pusher 22 in the feed direction T of the driven member t is a coiled leaf spring as shown in FIG. 7. Alternatively, a compression spring or a tension spring may be used as a pusher biasing member.

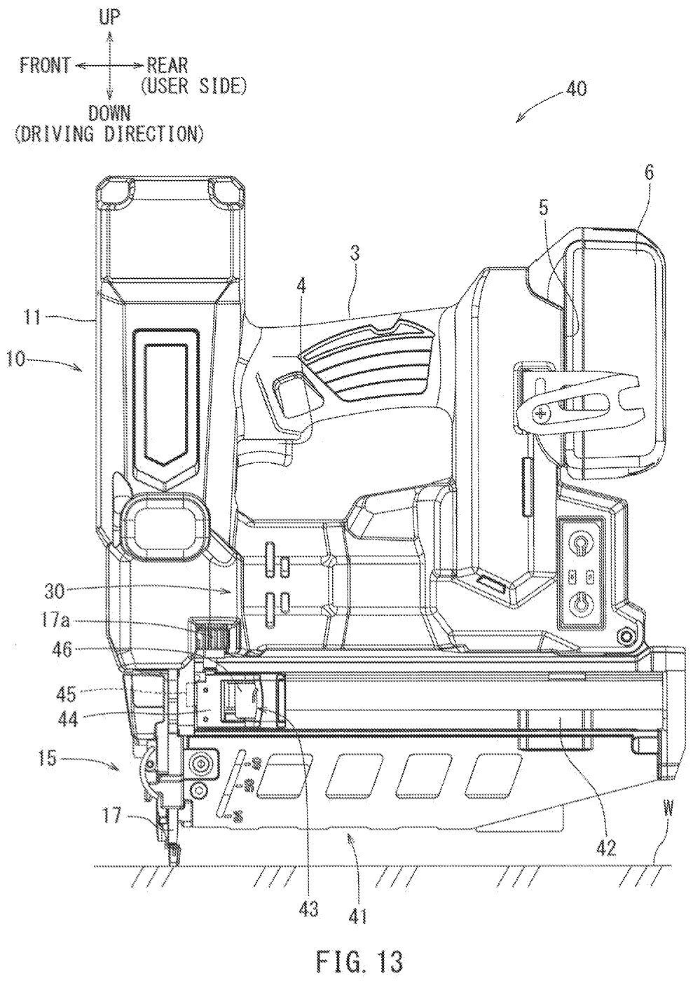

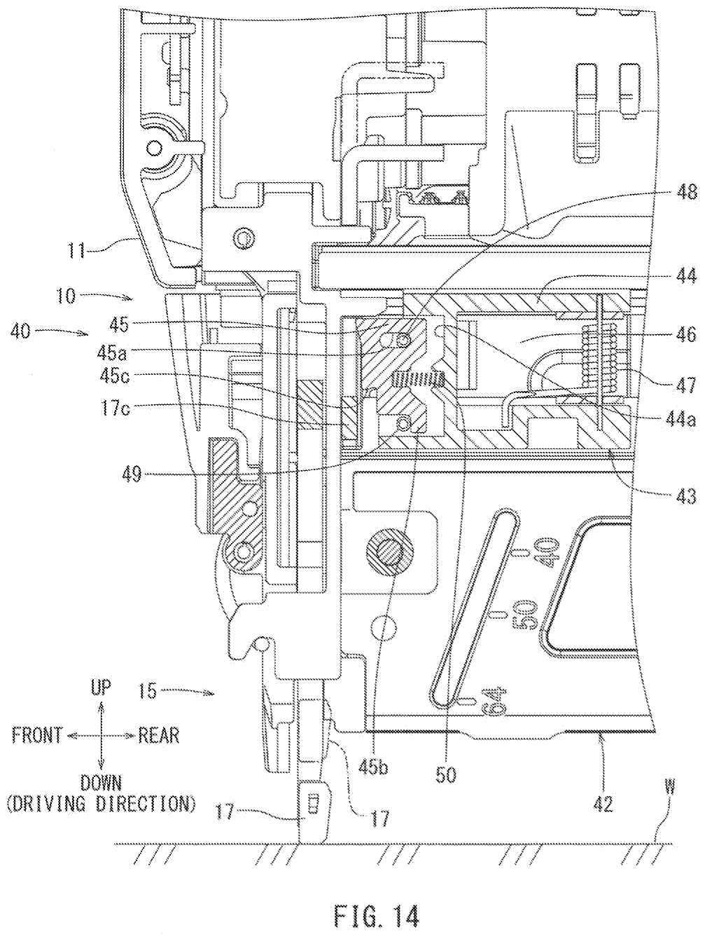

FIGS. 13 and 14 show a driving tool 40 according to the second example. The driving tool 1 according to the first example is used, for example, for joining construction post materials. For this purpose, it is equipped with a large magazine 20 capable of accommodating a number of relatively long driven members. The driving tool 40 according to the second example may be used, for example, for joining flooring materials. Therefore, it is provided with a compact magazine 41 capable of accommodating a large number of relatively short and thin driven members. In the second example, the configuration of the magazine 41, especially the lock member, is different from the first example. The components and configurations that do not require modification will not be described using the same reference numerals.

The driving tool 40 of the second example is also a gas spring type driving tool similar to the first example, and has a tool body 10 and a driving nose 15. A grip 3 extends rearward from the tool body 10. A battery mount 5 is provided at the rear of the grip 3. A battery pack 6 is mounted to the battery mount 5. A switch lever 4 for start-up operation is provided at a base of a lower side of the grip 3. Although not visible in the figure, the body housing 11 of the tool body 10 contains a cylinder 12, a piston 13, and a pressure accumulation chamber 14. A driver 2 having a plurality of engaging portions 2a is coupled to the piston 13. The driver 2 moves up and down in the driving channel 16a of the driver guide 16.

The driver guide 16 is coupled to a lower part of the tool body 10. A lift mechanism 30 is adjacent to the driver guide 16. A contact arm 17 is provided displaceable upward and downward with respect to the driver guide 16. When the contact arm 17 and the switch lever 4 are turned ON, the lift mechanism 30 is activated to perform the driving operation.

The magazine 41 is coupled to a rear side of driver guide 16. The magazine 41 extends rearward from the driver guide 16. The magazine 41 extends along a direction orthogonal to the driving direction. The magazine 41 has a magazine body 42 that accommodates a number of driven members t and a pusher 43.

As shown in FIG. 14, the pusher 43 has a holder 44, a lock member 45, and a pusher piece 46. The lock member 45 is supported on a left side (front side of FIG. 14) of the holder 44. The pusher piece 46 is provided on a right side of the holder 44 (back side of FIG. 14, on the side of the driven member t). The pusher piece 46 is biased by a torsion spring 47 in the direction of contacting a bottom of a housing portion of the magazine body 42 (toward the back of FIG. 14). The driven member t (not shown) is also located on the back side of the sheet in FIG. 14. Therefore, the pusher piece 46 can securely contact the driven member t.

Similar to the first example, the pusher 43 is pushed toward the driving channel by a coiled leaf spring (pusher biasing member). The force of pusher 43 causes pusher piece 46 to push driving channel t toward the driving channel (left side in FIG. 14).

The lock member 45 according to the second example has a flat plate shape. The lock member 45 is supported within a guide portion 44a opening in the front side of the holder 44. The lock member 45 is slidably supported along a plane that includes the feed direction of the driven member t in a position with its plane direction being parallel to the plane including the feed direction T of the driven member t (movement direction of the pusher 43). The lock member 45 is restricted from moving in the direction of being removed from the guide portion 44a by two restricting portions 48, 49. The upper restricting portion 48 is located in the front-to-back elongated groove hole 45a. The lower restricting portion 49 is in contact with the front side of the contact portion 45b provided on a lower part of the lock member 45.

One compression spring 50 is interposed between the lock member 45 and the back part of the guide portion 44a. The compression spring 50 biases the lock member 45 in the direction of being removed from the guide portion 44a (toward the driving channel). The lock member 45 is backward slidably supported against the biasing force of the compression spring 50. The compression spring 50 corresponds to the lock biasing member.

An engaging portion 45c is formed at a front portion of the lock member 45. The last allowable driven member t (the driven member t immediately before the idle striking prevention is activated) is struck. As a result, the remaining number of driven members t in the magazine 41 reaches the predetermined number. The lock member 45 then enters the movement path of the contact arm 17. The locking portion 17c of the contact arm 17 is thus engaged from below with the engaging portion 45c of the lock member 45, thereby restricting the ON operation of the contact arm 17. As a result, the idle striking is prevented when the remaining driven members t in the magazine 41 reaches a certain number.

Similar to the first example, the biasing force of the compression spring 50 configured to bias the lock member 45 in the feed direction T is smaller or weaker than the biasing force of the leaf spring (pusher biasing member) that biases the pusher 43 in the feed direction T. Therefore, for example, if the lock member 45 is pressed against the contact arm 17 from behind while the contact arm 17 returns from the ON position to the OFF position (downward in FIG. 14), the lock member 45 retracts against the compression spring 50 such that the pusher 43 moves in the feed direction T by the pusher biasing member. This ensures that the driven members t is fed toward the driving channel in the proper posture, and the contact arm 17 is smoothly returned to the OFF position.

According to the second example, a flat plate-shaped lock member 45 enters the movement path of the contact arm 17, thereby restricting the ON operation of the contact arm 17 and preventing idle striking. The lock member 45 is provided on the pusher 43 slidably along a plane that includes the movement direction of the pusher 43 (feed direction T of the driven member t).

Therefore, similar to the first example, the lock member 45 can be movably incorporated in a limited space without requiring a large space like a conventional rotary type lock member. In this aspect, the illustrated idle striking prevention mechanism (lock member 45) can be more easily incorporated into the gas spring type driving tool 40, for which a large space cannot be ensured, for example, when the lift mechanism 30 is disposed around the driving nose 15.

In addition, a lock member 45 for restricting the movement of the contact arm 17 is provided in the pusher 23 to prevent idle striking. This makes it easier to incorporate the lock member 45 into the magazine compared to the conventional idle striking preventive configuration in which the lock member is incorporated into the magazine separately from the pusher.

Further modifications may be made to the first and second examples described above. For example, a position of the lock member 28, 45 with respect to the holder 24, 44 or a length of the lock member 28, 45 in the feed direction T may be changed such that the remaining number of driven members t to be prevented from idle striking can be changed. For example, the position of the lock member 28, 45 relative to the holder 24, 44 may be changed or the length of the lock member 28, 45 in the feed direction T may be changed such that the lock member 28, 44 enters the movement path of the contact arm 17 when the remaining number of driven members t within the magazine 20, 41 reaches zero or a few.

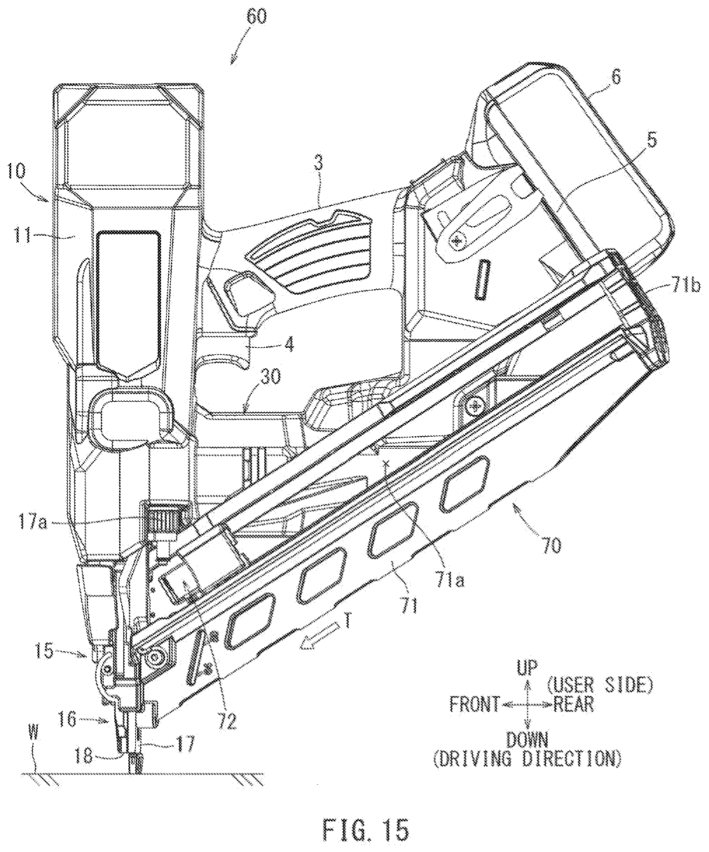

FIG. 15 shows a driving tool 60 according to the third example. The driving tool 60 according to the third example is a gas spring type driving tool similar to that of the first and second examples, and has a tool body 10 and a driving nose 15. The tool body 10 contains a cylinder 12 and a piston 13. The driving channel 16a is provided in the driving nose 15, through which the driver 2 reciprocally moves upward and downward. The components and configurations that do not require modification, such as the grip 3, the battery mount 5, or the lift mechanism 30 will not be described using the same reference numerals as those in the first and second examples.

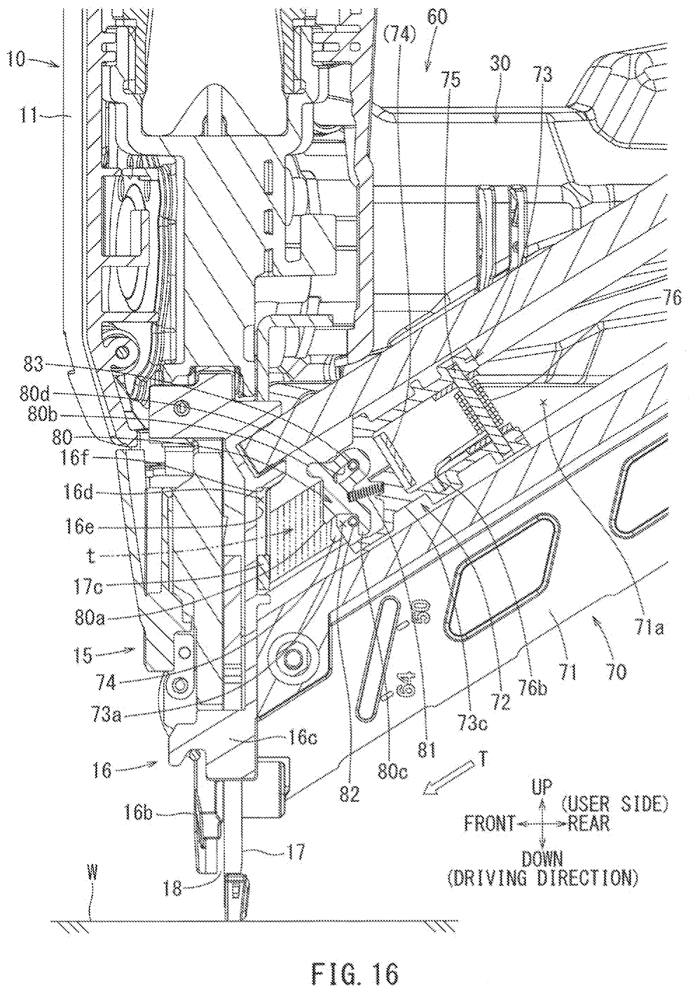

The driving tool 60 according to the third example is a so-called angle nailer, which, similar to the first example, is equipped with a magazine 70 in which the feed direction T of the driving tool t is inclined with respect to the driving direction. The magazine 70 is equipped with a lock member 80 shown in FIG. 16, which differs from that of the first example.

As shown in FIG. 16, the driver guide 16 according to the third example has a configuration in which a front guide portion 16b and a rear guide portion 16c are coupled while being mutually overlapped frontward and rearward. A driving channel 16a (see FIG. 2) is formed between the front guide portion 16b and the rear guide portion 16c. A contact arm 17 is supported by the driver guide 16 in a vertically displaceable manner. The contact arm 17 is biased downward to the OFF position by a compression spring (not visible in the figure). In the OFF position, the contact arm 17 protrudes downward from a lower part (ejection port 18) of the driver guide 16. As shown in FIG. 15, a dial 17a for adjusting the driving depth is provided at an upper part of the contact arm 17.

As shown in FIG. 16, the magazine 70 has a magazine body 71 configured to accommodate the driven members t and a pusher 72 configured to push the driven member t in the feed direction T. A front end of the magazine body 71 is coupled the rear guide portion 16c of the driver guide 16. An interior of the magazine body 71 (housing section 71a for the driven members t) passes through the rear guide portion 16c to communicate the driving channel. The magazine body 71 extends backward and diagonally upward from the driver guide 16. A loading port 71b (see FIG. 15) for the driven members t is provided at a rear part of the magazine body 71.

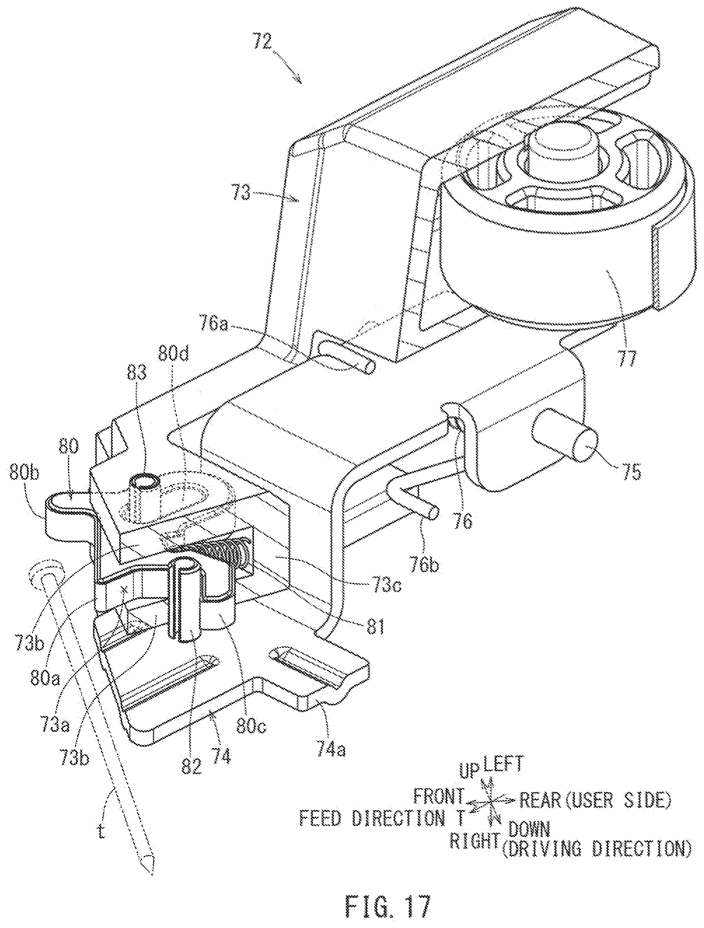

As shown in FIGS. 16 and 17, the pusher 72 is movably supported on the magazine body 71 along the feed direction T. The pusher 72 has a holder 73, a pusher piece 74, and a lock member 80. The holder 73 is movably supported to the magazine body 71 along the feed direction T. The pusher 72 is biased in the feed direction T by a pusher biasing member 77 housed in a rear part of the holder 73. An end of the pusher biasing member 77 is hooked to a front part of the magazine body 71.

The pusher piece 74 is rotatably supported on the holder 73 in a direction (left-right direction) to move its front side closer to and away from a bottom of the housing section 71a via a support shaft 75. A torsion spring 76 is attached to the support shaft 75. One end 76a of the torsion spring 76 is engaged with an upper surface of the pusher piece 74. The other end 76b of the torsion spring 76 is engaged with the holder 73. The pusher piece 74 is thus pushed in a direction (to right) to allow its front side to contact with the bottom of the housing section 71a. The driven members t are also located at the bottom of the housing section 71a. Therefore, the front side of the pusher piece 74 securely contacts the driven member t.

As shown in FIG. 17, upper and lower edges of a front side of the pusher piece 74 are each provided with a guide section 74a. The upper and lower guide sections 74a enter upper and lower guide grooves (not shown) formed in the magazine body 71. This allows the front part of the pusher piece 74 to be movably guided in the feed direction T. When the pusher 72 is manually moved backward, the upper and lower guiding sections 74a reach a wider part of the guide groove (not visible in the figure). This allows the front side of the pusher piece 74 to displace in a direction moving it away from the bottom of the housing section 71a. The front side of the pusher piece 74 is lifted from the bottom of the housing section 71a against the torsion spring 76, allowing the driven members t loaded from the loading port 71b to move beyond the pusher piece 74 to the forward side in the feed direction T. By releasing the manual operation, the driven member t is then pushed in the driving direction T by the pusher piece 74.

As shown in FIGS. 16 and 17, an up-down elongated opening 73a is formed at a front part of the holder 73. A flat plate-shaped lock member 80 is supported between left and right walls 73b that define the opening 73a. The lock member 80 is supported displaceable between the left and right walls 73b along a plane that includes the movement direction of the pusher 72 (feed direction T of the driven member t). The lock member 80 is movably supported in a direction different from the movement direction of the pusher 72 or the movement direction of the pusher 72.

The lock member 80 has an engaging portion 80a and a contact portion 80b at a front side of the feed direction T. The engaging portion 80a and the contact portion 80b are mutually spaced at a predetermined interval in an up-down direction. The lower engaging portion 80a has a substantially chevron shape and projects forward. The contact portion 80b has a substantially semi-circular shape and projects forward.

A rear side of the lock member 80 is provided with a lower arm portion 80c and an upper guide portion 80d. The arm portion 80c protrudes substantially downward. The guide portion 80d is a groove or hole extending substantially rearward. A rear wall 73c, which is a part of the holder 73, is provided behind the lock member 80. A lock biasing member 81 is interposed between the arm portion 80c and the guide portion 80d at the rear part of the lock member 80 and the rear wall 73c of the holder 73. A compression spring is used for the lock biasing member 81. The lock biasing member 81 biases the lock member 80 substantially forward in the feed direction T.

Two engagement shafts 82, 83 are provided between the left and right walls 73b of the holder 73. The arm portion 80c of the lock member 80 comes in contact with the lower engagement shaft 82 from rear. The arm portion 80c is pressed against the engagement shaft 82 due to the biasing force of the lock biasing member 81 and is maintained being in contact at all times. The upper engagement shaft 83 enters the guide portion 80d of the lock member 80. The lock member 80 is allowed to move to the extent that the engagement shaft 83 is relatively displaceable within the guide portion 80d.

As shown in FIG. 16, a guide recess 16d is provided in a rear guide portion 16c of a driver guide 16 in front of the lock member 80. A depth direction of the guide recess 16d corresponds to a front-back direction and the guide recess 16d is elongated in an up-down direction. A locking portion 17c that is integrally formed with the contact arm 17 is guided along the guide recess 16d so as to be displaceable upward and downward. When the contact arm 17 is turned ON upward, the locking portion 17c displaces upward within the guide recess 16d.

The bottom of the guide recess 16d (rear side of the driver guide 16) is an abutment face 16e. A restricting surface 16f is formed at a top of the abutment face 16e. The restricting surface 16f corresponds to an upper surface of the guide recess 16d and extends at substantially a right angle to the abutment face 16e.

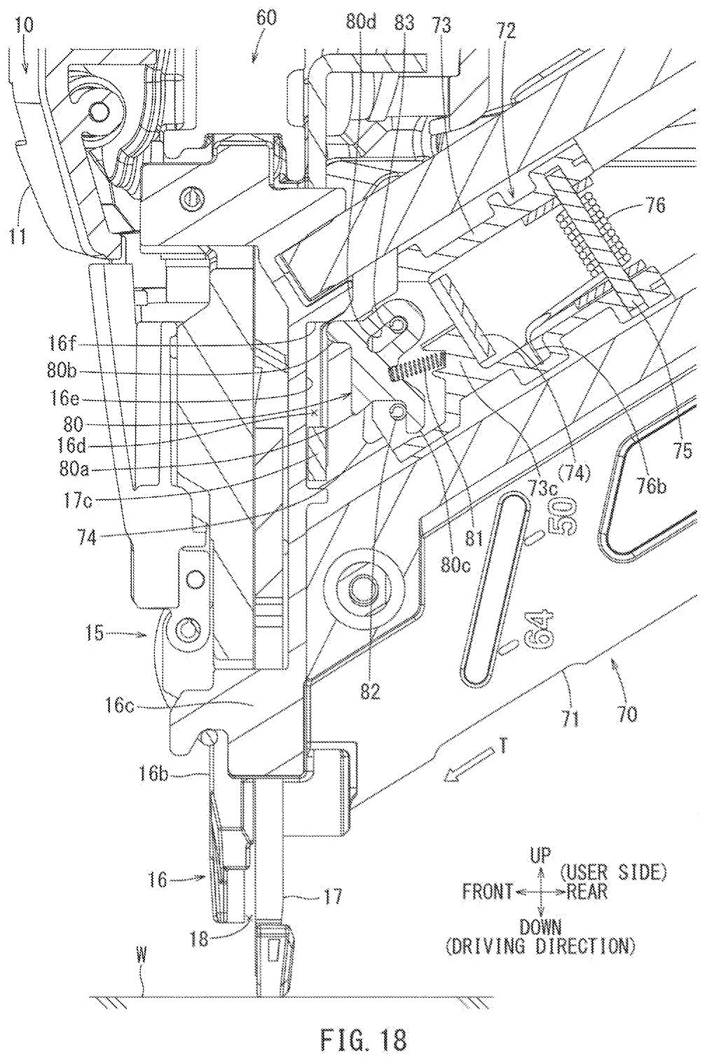

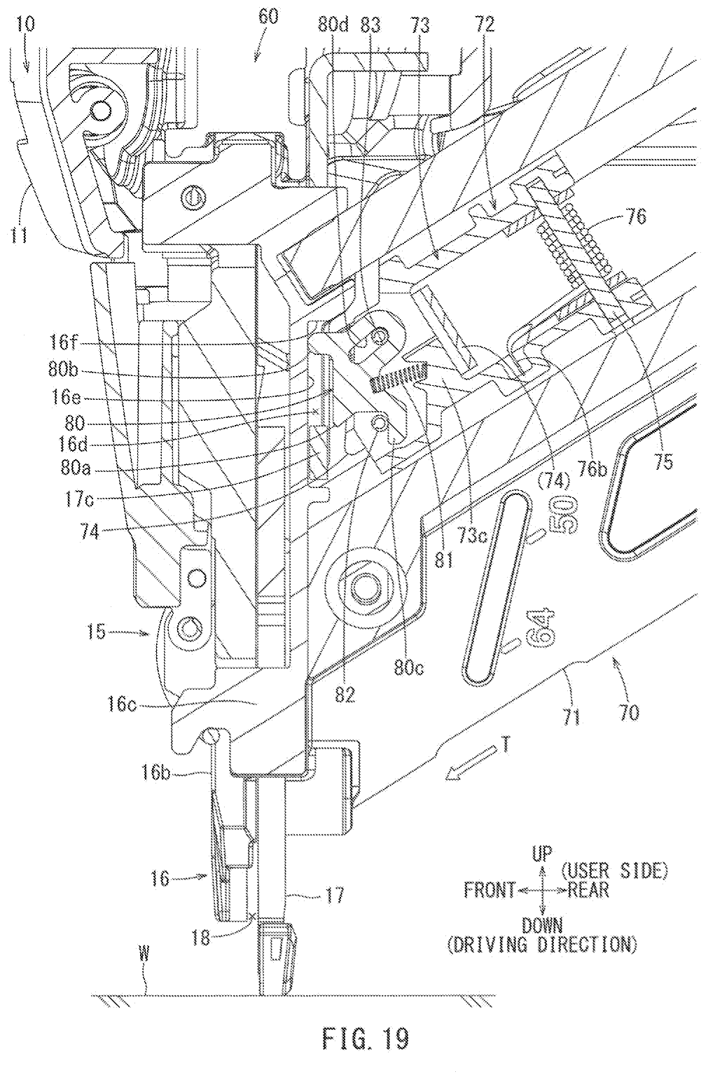

FIGS. 16 and 18 show more than a certain number of driven members t remaining in the magazine 70. Therefore, the pusher 72 is shifted backward away from the driving channel. In this state, the lock member 80 is located in an unlocked position pushed forward in the feed direction T by the lock biasing member 81. In the unlocked position of the lock member 80, the lower engagement shaft 82 contacts a base (upper) side of the arm portion 80c and the upper engagement shaft 83 contacts a rear part of the guide portion 80d.

As shown in FIG. 19, when the remaining number of driven members t in the magazine 70 is reduced, the pusher 72 moves forward in the feed direction T. When, for example, only one driven member t that can be driven remains, the contact portion 80b of the lock member 80 is pressed against the abutment face 16e of the guide recess 16d.

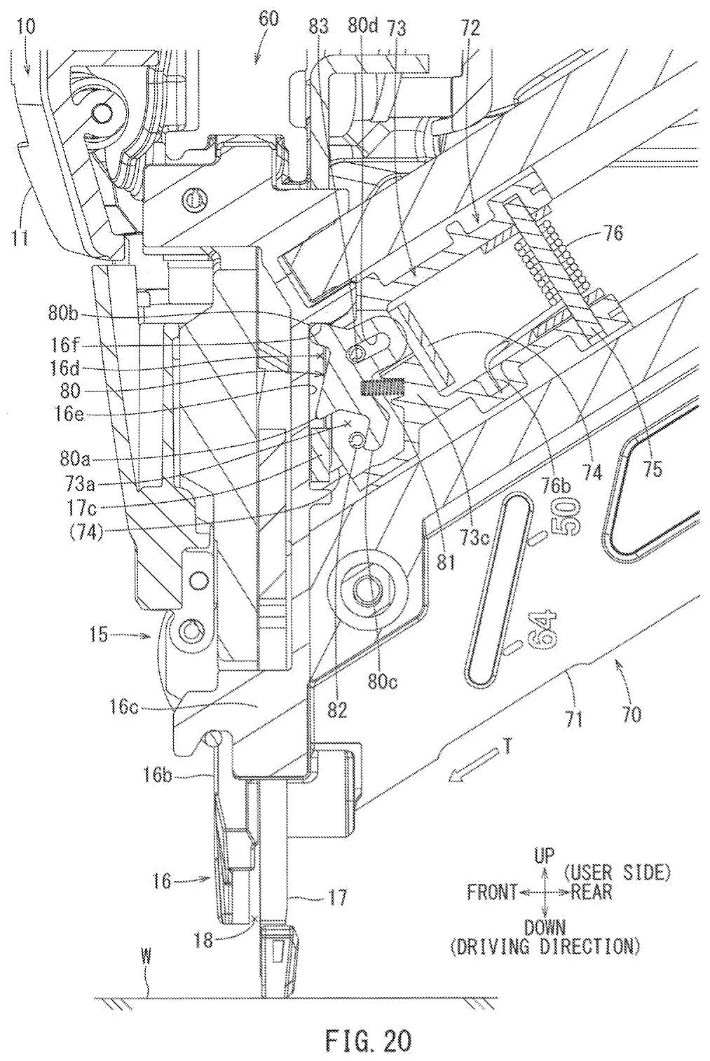

When the driver 2 returns to the upper stand-by position (see FIG. 2) after the last drivable driven members t was driven, the pusher 72 moves forward by a distance equivalent to one driven member t as shown in FIG. 19. The pusher 72 moves forward in the feed direction T with the contact portion 80b of the lock member 80 being pressed against the abutment face 16e of the guide recess 16d. As shown in FIG. 20, the contact portion 80b is therefore displaced upward and contacts the restricting surface 16f of the guide recess 16d, and the lock member 80 with its upper side is displaced backward diagonally upward against the lock biasing member 81 so as to be displaced in the locked position with its lower side displaced forward diagonally upward. In other words, the entire lock member 80 rotates in an illustrated clockwise direction around the substantially lower engagement shaft 82 by the biasing force of the lock biasing member 81. As a result, the lock member 80 is displaced from the unlocked position shown in FIGS. 18 and 19 to the locked position shown in FIG. 20 with respect to the holder 73.

After the last drivable driven member t that can be driven in this way, the pusher 72 moves forward in the feed direction T to displace the lock member 80 to the locked position shown in FIG. 20. When the lock member 80 is displaced to the locked position, an end side of the arm portion 80c abuts the lower engagement shaft 82 such that the upper engaging portion 83 is in contact with the end portion of the guide portion 80d. As a result, the contact portion 80b is pressed against the restricting surface 16f by the biasing force of the lock biasing member 81, and the lock member 80 is held in the locked position.

When the lock member 80 is displaced to the locked position, the engaging portion 80a enters the guide recess 16d. This causes the engaging portion 80a of the lock member 80 to enter the movement path of the locking portion 17c of the contact arm 17. The engaging portion 80a enters above the locking portion 17c. As a result, an upward displacement of the locking portion 17c is restricted and an ON operation of the contact arm 17 is restricted. Since the contact portion 80b is pressed against the restricting surface 16f to securely hold the lock member 80 in the locked position, the engagement portion 80a securely restricts the upward displacement of the locking portion 17c. As a result, the driving operation is restricted after the remaining number of driven members t reached a certain number (idle striking prevention mechanism).

According to the third example, the engagement portion 80a of the lock member 80 enters the movement path of the contact arm 17, thereby restricting the ON operation of the contact arm 17 and preventing idle striking. The lock member 80 is provided on the pusher 72 to be displaceable along a plane that includes the movement direction of the pusher 72 (feed direction T of the driven member t). Therefore, the third example does not require a large space like a conventional rotary type lock member, and the lock member 80 is provided on the pusher 72 to realize a more compact configuration than the conventional one for preventing idle striking.

According to the third example, the lock member 80 is provided displaceable in the pusher 72 in a direction different from the movement direction of the pusher 72. Accordingly, the lock member 80 may be compactly arranged in the pusher 72. Compared to the first example in which the lock member 28 advances and retracts along the movement direction of the pusher 22 as shown in FIG. 8, the third example shown in FIG. 20 can displace the lock member 80 in a more compact space in the movement direction of the pusher 72.

According to the third example, the lock member 80 has the engaging portion 80a at the bottom, which is the driving direction, and the contact portion 80b at the top. Accordingly, the upper contact portion 80b is restricted from being displaced upward by the restricting surface 16f of the tool body 10 such that the lock member 80 is displaced to allow the engaging portion 80a to enter the movement path of the contact arm 17.

According to the third example, the contact portion 80b is a portion projecting toward the tool body 10. Therefore, the contact portion 80b abuts the restricting surface 16f of the tool body 10 to ensure that upward displacement is reliably restricted.

According to the third example, the lock member 80 rotates along a plane that includes the movement direction of the pusher 72. Therefore, the lock member 80 is displaced in a more compact space with respect to the movement direction of the pusher 72.

According to the third example, in the magazine 70, the driven members t are fed toward the driving direction as it approaches the driving channel 16a. Therefore, for angle-type driving tools 60 in which the feed direction of the driven members t is inclined to the driving direction, the lock member 80 compactly incorporated in the pusher 72 provides reliable idle striking prevention.

The various examples described in detail above, with reference to the attached drawings, are intended to be representative of the present disclosure, and are thus non-limiting embodiments. The detailed description is intended to teach a person of skill in the art to make, use, and/or practice various aspects of the present teachings, and thus does not limit the scope of the disclosure in any manner. Furthermore, each of the additional features and teachings disclosed above may be applied and/or used separately or with other features and teachings in any combination thereof, so as to provide an improved driving tool, and/or methods of making and using the same.

What is claimed is:

1. A driving tool comprising:
a driver configured to drive a driven member into a workpiece;
a lift mechanism configured to return the driver in a direction opposite to a driving direction of the driven member;
a contact arm pressed against the workpiece and configured to move with respect to a tool body for a driving operation of the driver;
a magazine configured to load the driven member;
a pusher moveable within the magazine configured to push and load the driven member into a driving channel of the driver; and
a lock member capable of being displaceable in the pusher along a plane that includes a movement direction of the pusher, wherein the lock member enters a movement path of the contact arm to restrict the movement of the contact arm.

2. The driving tool according to claim 1, wherein the driven member is configured to encounter a lateral side of an end in the driving direction of the driver in a stand-by position.

3. The driving tool according to claim 2, wherein the driven member is pushed and loaded by the pusher into the driving channel of the driver while the driver reaches a top dead center from the stand-by position.

4. The driving tool according claim 1, wherein the lock member is displaceable within the pusher in a direction parallel to the movement direction of the pusher.

5. The driving tool according to claim 1, wherein the lock member is displaced to a retracted position when its distal end face butted against the contact arm.

6. The driving tool according to claim 1, wherein the pusher has a guide portion movable to support the lock member and a removal preventing member configured to prevent the lock member from being removed from the guide portion.

7. The driving tool according claim 6, wherein the lock member is a plate-like member including:
a support portion located within the guide portion, and an engaging portion located outside the guide portion and bent against the support portion extending along a plane across the guide portion.

8. The driving tool according to claim 1, wherein the lock member is displaceable in the pusher in a direction different from the movement direction of the pusher.

9. The driving tool according to claim 8, wherein the lock member has an engaging portion located at a bottom in the driving direction and a contact portion located at a top, wherein the contact portion is restricted from being displaced upward by a restricting surface of the tool body, and wherein the engaging portion enters the movement path of the contact arm.

10. The driving tool according to claim 9, wherein the contact portion is configured to protrude toward the tool body.

11. The driving tool according to claim 8, wherein the lock member is configured to rotate along a plane including the movement direction of the pusher.

12. The driving tool according to claim 1 further comprising:
a pusher biasing member configured to bias the pusher toward the driving channel; and
a lock biasing member configured to bias the lock member in a direction projecting from the pusher.

13. The driving tool according to claim 12, wherein a force of the lock biasing member is weaker than a biasing force of the pusher biasing member.

14. The driving tool according to claim 1, wherein the pusher includes a holder in which the lock member is displaceable and a pusher piece that is rotatably provided on the holder and is in contact with the driven member.

15. The driving tool according to claim 1, wherein the driven member is loaded in the driving direction as the driven member comes closer to the driving channel.

16. The driving tool according to claim 1, wherein the driver has a coupled piston, and wherein a movement of the coupled piston generates gas pressure that causes the driver to perform a driving operation.

17. A driving tool comprising:
a driver configured to drive a driven member into a workpiece, wherein the driver has a plurality of engaging portions, and the driver is coupled to a piston;
a lift mechanism sequentially engageable with the plurality of engaging portions for returning the driver in a direction opposite to a driving direction of the driven member;
a driving nose allocated at a lower part of a tool body, wherein the driving nose includes
a driver guide coupled to a lower part of the tool body, and
a contact arm pressed against the workpiece and configured to move with respect to the tool body for performing a driving operation of the driver;
a magazine coupled to a rear side of the driver guide and configured to load the driven member;
a pusher configured to push the driven member toward a driving channel of the driver, wherein the pusher includes a holder, a lock member, and a pusher piece; and
a lock member capable of being displaceable in the pusher along a plane in a movement direction of the pusher, wherein the lock member encounters a movement path of the contact arm therewith for restricting the contact arm from being movable.

18. The driving tool according to claim 17, wherein the pusher comprises a pusher claw supported by the holder via a support shaft, wherein the holder has an upper guide edge allocated on an upper surface of the holder and a lower guide edge allocated on a lower surface of the holder.

19. The driving tool of claim 18, wherein the magazine comprises
an upper guide rail configured to hold the upper guide edge, and
a lower guider rail configured to hold the lower guide edge.

20. The driving tool according to claim 17, wherein the pusher piece is biased by a torsion spring having a first end engageable with an upper surface of the pusher piece and a second end engageable with the holder.
